(19) United States
(12) Patent Application Publication
(10) Pub. No.: US 2008/0229687 A1
(43) Pub. Date: Sep. 25, 2008

(54) SYSTEMS AND METHODS FOR WINDOW PROTECTION

(76) Inventors: Don A. Huggins, Evergreen, CO (US); Harry W. Rhulen, Evergreen, CO (US)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(21) Appl. No.: 12/035,275

(22) Filed: Feb. 21, 2008

Related U.S. Application Data
(60) Provisional application No. 60/891,001, filed on Feb. 21, 2007.

(51) Int. Cl. E06B 5/10

(52) U.S. Cl. 52/203

(57) ABSTRACT

Embodiments of a system for protecting a window include an attachment element including retaining element and a suction element, with the suction element configured to engage an underlying surface. According to some embodiments, a protective sheet is placed between the retaining element and the underlying surface and a tensioning element creates suction between the suction element and the underlying surface.

### CROSS-REFERENCE TO RELATED APPLICATION

This application claims the benefit of U.S. Provisional Patent Application Serial No. 60/891,001, filed Feb. 21, 2007, which is herein incorporated by reference in its entirety.

### TECHNICAL FIELD

Embodiments of the present invention relate generally to window protection, and more particularly to a device applied externally to a window for blocking wind-blown debris and preventing shattering of the window.

### BACKGROUND

Each year, natural disasters involving strong wind cause damage to windows on residential and commercial buildings. Debris blown by wind can shatter windows, posing a safety hazard due to flying glass and debris. In addition, the breach of one or more windows during a storm can lead to a pressure differential sufficient to lift all or part of the roof off of a building.

When warned of an impending storm, such as a hurricane, many residents and business owners flock to home improvement stores and lumber yards to buy plywood sheets to bolt, nail, or screw over windows to protect them from being shattered by wind, rain, and/or debris. However, plywood sheets can be expensive and also extremely scarce in the times leading up to such storms. Attaching plywood sheets or conventional boards to a building structure can damage the external building structure and/or window frame, and some such installations require a building permit from local authorities. Furthermore, covering windows with plywood often does not permit any sunlight to pass through the window.

### SUMMARY

Embodiments of the present invention include systems and methods for window protection. Embodiments of the systems for protecting a widow include an attachment element having a retaining element and a suction element, the suction element is configured to engage an underlying surface such as, for example, a window pane. According to embodiments of the present invention a protective sheet is placed between the retaining element and the underlying surface. According to embodiments of the present invention, a tensioning element is configured to create a suction between the suction element and the underlying surface. In some embodiments the retaining element includes a neck and a retention plate, where the retention plate includes a hole. In some embodiments the suction element includes a suction cup and a stem where the stem may pass through the hole in the retention plate when the neck comes in contact with the suction cup.

Embodiments of a method for protecting windows include providing a suction element with a suction cup and a stem extending from the suction cup, positioning the suction cup on a window pane with the stem extending away from the window pane, creating a first hole in a protective sheet configured to withstand windblown debris, positioning the protective sheet over the suction element such that the stem passes through the first hole, and providing a retaining element having a neck and a retention plate. Such embodiments of methods may further include positioning the retaining element over the suction element, such that the neck passes through the first hole and abuts the suction cup and the stem protrudes through a hole formed in the retention plate, placing a tensioning knob on the stem, and adjusting the tensioning knob to create a suction between the suction cup and the window pane, thereby holding the protective sheet between the retention plate and the window pane.

According to some embodiments of the present invention, components used for protecting a window may be sold in a kit. For example, such a kit may include one or more retaining elements having a neck and a retention plate, one or more suction elements comprising a suction cup and a stem extending from the suction cup, and one or more tensioning knobs configured to interface with the stem, such that an adjustment of the tensioning knob axially displaces the stem to create suction between the suction cup and an underlying surface while holding the retaining element to the underlying surface. According to embodiments of the present invention, a kit may further include a protective sheet configured to be held between the retention plate and the underlying surface.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 illustrates a side cross sectional view of a retaining element according to embodiments of the present invention.

FIG. 2 illustrates a bottom view of a retaining element according to embodiments of the present invention.

FIG. 3 illustrates a side cross sectional view of an attachment element and tensioning element, according to embodiments of the present invention.

FIG. 4 illustrates a side cross sectional view of the attachment element and tensioning element of FIG. 3 in a suction configuration, according to embodiments of the present invention.

FIG. 5 illustrates a top view of a retaining element according to embodiments of the present invention.

FIG. 6 illustrates a bottom view of a retaining element according to embodiments of the present invention.

FIG. 7 illustrates a top view of a suction element according to embodiments of the present invention.

FIG. 8 illustrates a side view of a suction element according to embodiments of the present invention.

FIG. 9 illustrates a top view of a tensioning knob according to embodiments of the present invention.

FIG. 10 illustrates a bottom view of a tensioning knob according to embodiments of the present invention.

FIG. 11a illustrates a top perspective view of a protective sheet according to embodiments of the present invention.

FIG. 11b illustrates a top perspective view of a cutting tool according to embodiments of the present invention.

FIG. 11c illustrates a perspective view of multiple protective sheets installed on a building, according to embodiments of the present invention.

FIG. 12 illustrates a neck portion of a retaining element inserted through a hole in the protective sheet, according to embodiments of the present invention.

FIG. 13 illustrates a suction element inserted on a protective sheet according to embodiments of the present invention.

FIG. 14 illustrates a top perspective view of a retaining element inserted into a sample protective sheet, with a suction stem protruding through a hole in the retaining element, according to embodiments of the present invention.

FIG. 15 illustrates a top perspective view of a tensioning knob attached to a suction stem protruding through a retaining element, according to embodiments of the present invention.

FIG. 16 illustrates a side view of an attachment element and tensioning element, according to embodiments of the present invention.

FIG. 17 illustrates a illustrates a side cross sectional view of an attachment element and tensioning element, according to embodiments of the present invention.

FIG. 18 illustrates a method for protecting windows, according to embodiments of the present invention.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

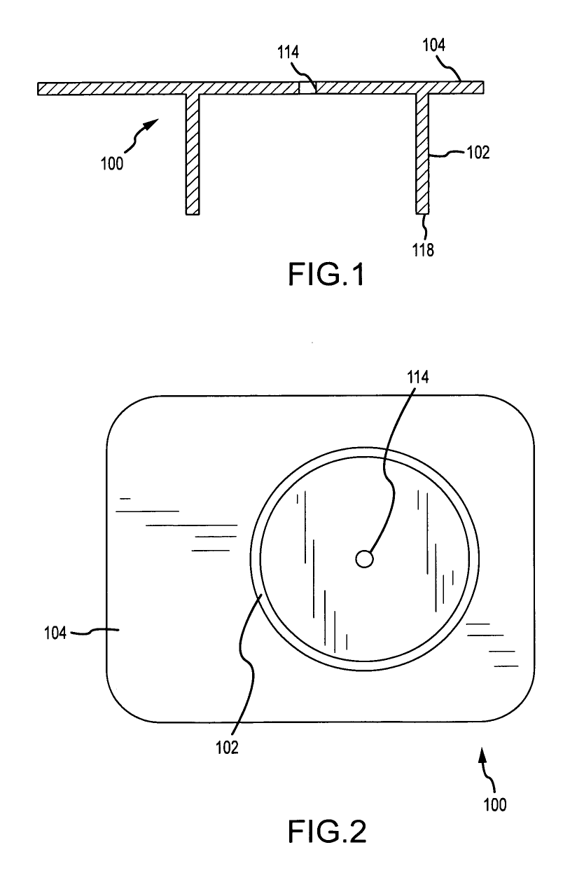

FIG. 1 illustrates a side cross sectional view, and FIG. 2 illustrates a bottom view of a retaining element 100 according to embodiments of the present invention. According to embodiments of the present invention, retaining element 100 includes a neck 102, a retention plate 104, and a hole 114 formed through the retention plate 104 above the neck 102. Neck 102 may be formed in a tubular shape either integrally with retention plate 104 through a molding or other process, or formed separately from retention plate 104 and attached thereto in a later step. Retaining element 100 may be made in an injection molding process with an injection moldable material according to embodiments of the present invention, such as, for example, plastic.

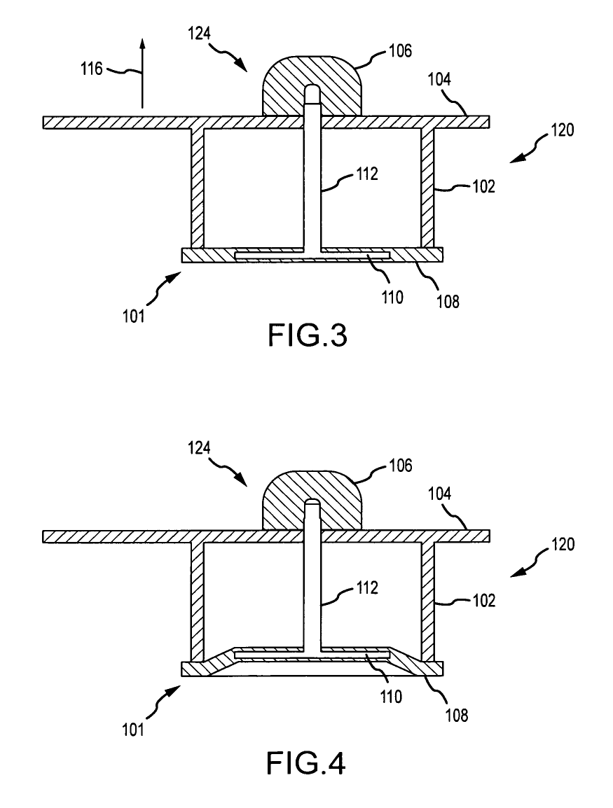

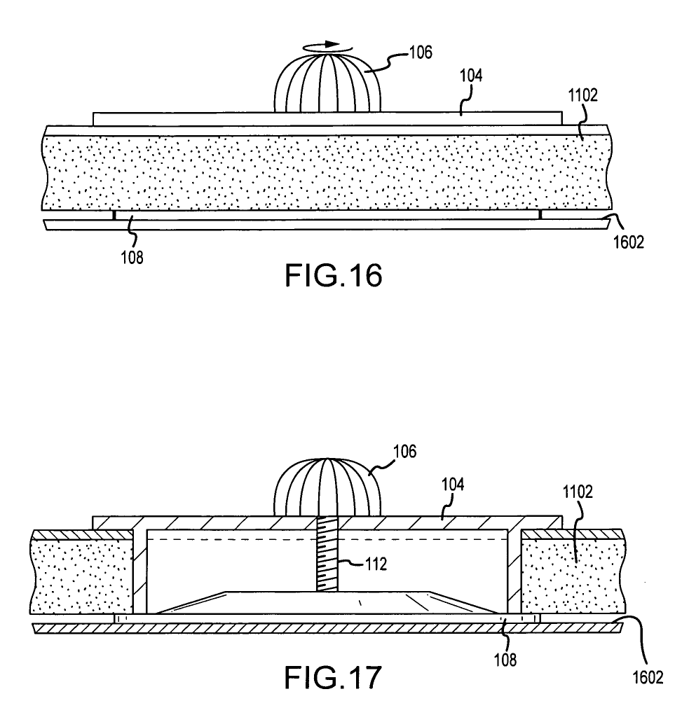

FIG. 3 illustrates a side cross sectional view of an attachment element 120 and a tensioning element 124 according to embodiments of the present invention. FIG. 4 illustrates a side cross sectional view of an attachment element 120 and a tensioning element 124 in a suction configuration, according to embodiments of the present invention. The attachment element 120 and tensioning element 124 may be attached to an underlying surface 1602 (as illustrated in FIGS. 16 & 17) through a suction or vacuum connection, according to embodiments of the present invention. The underlying surface 1602 may be, for example, glass or a window pane.

According to embodiments of the present invention, attachment element 120 includes retaining element 100 and suction element 101. Retaining element 100 has a retention plate 104, neck 102, and a hole 114, according to embodiments of the present invention. The suction element 101 may have, for example, a stem 112 connected to a displacement disk 110 which is located within a suction cup 108.

According to embodiments of the present invention, tensioning element 124 consists of a tensioning knob 106 which interfaces with the stem 112. The tensioning knob 106 may be adjusted to axially displace the stem 112 away from the underlying surface 1602 which will create a vacuum or suction between the suction cup 108 and the underlying surface 1602. According to other embodiments of the present invention, the tensioning element 124 may consist of a stem 112 and a tensioning knob 106. According to embodiments of the present invention, the stem 112 is connected to the suction cup 108 and an adjustment of the stem 112 and/or the tensioning knob 106 creates a vacuum or suction between the suction cup 108 and the underlying surface 1602.

According to embodiments of the present invention, one end 118 of neck 102 contacts the top of suction cup 108, and stem 112 has a length which permits it to protrude through hole 114 when neck 102 contacts suction cup 108, according to embodiments of the present invention. Stem 112 is connected to and/or protrudes from a displacement disk 110 within suction cup 108. Movement of stem 112 in a direction substantially as depicted by arrow 116 causes a corresponding movement of displacement disk 110, which causes the center of suction cup 108 to be lifted in direction of arrow 116 while the outer portions of suction cup 108 remain between the bottom end 118 of neck 102 and the underlying surface 1602, such as the underlying window pane. This causes a suction and/or vacuum to be created in the space between suction cup 108 and the window pane as depicted in FIG. 4, thereby securely holding the suction cup 108 to the window pane, according to embodiments of the present invention. Suction cup 108 may be made from a rubber material, and displacement disk 110 and stem 112 may be made from steel, according to embodiments of the present invention.

According to some embodiments of the present invention, an outer surface or a portion of an outer surface of stem 112 may be threaded to correspond with a threaded inner surface of tensioning knob 106. Tensioning knob 106 may be threadably connected to stem 112 after stem 112 has been placed through hole 114 in retention plate 104. Turning tensioning knob 106 in one direction causes stem 112 to enter further into tensioning knob 106, thereby moving displacement disk 110 in a direction indicated by arrow 116. This causes suction cup 108 to be strongly adhered to the underlying surface, such as a window pane.

Tightening the tensioning knob 106 also serves to further hold retaining element 100 onto suction element 101, which also serves to hold a protective sheet onto the window between retention plate 104 and the underlying pane. According to some embodiments of the present invention, the depth of the threaded receiving hole in tensioning knob 106 may be customized to permit varying levels of displacement for suction cups 108 of different sizes and other properties, or based on characteristics of different window surfaces to which suction cup 108 may be applied.

The bottom end 118 of neck 102 may also be rounded or otherwise shaped to minimize leakage in a suction configuration. In other words, bottom end 118 of neck 102 may be shaped other than a flat end with two distinct corners. For example, bottom end 118 may be rounded slightly, and/or may have an alternative geometry which minimizes leakage.

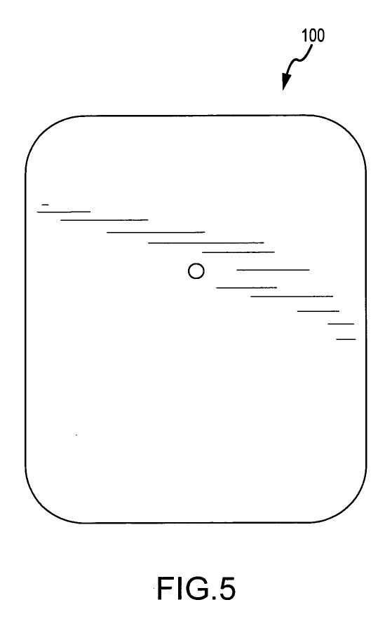

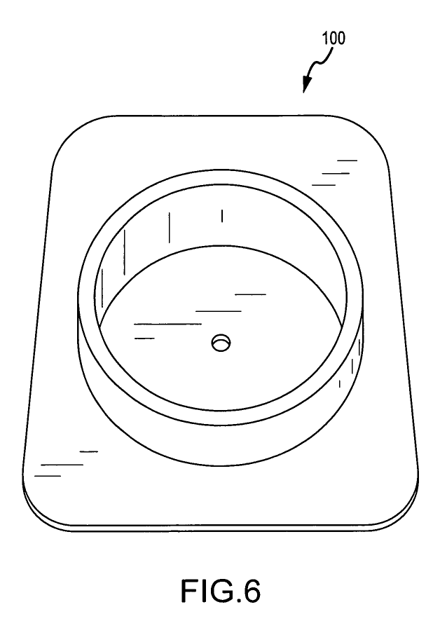

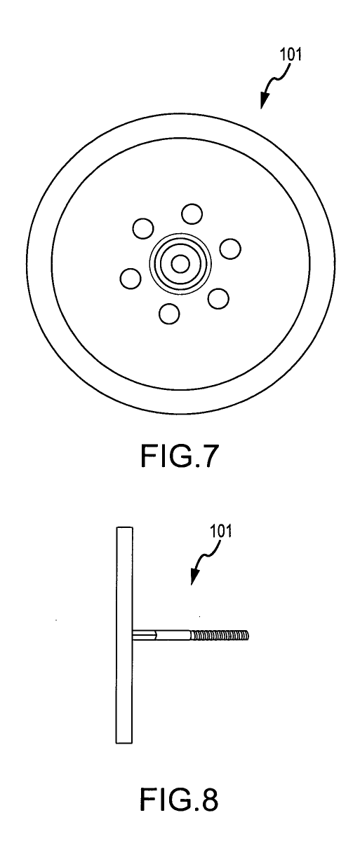

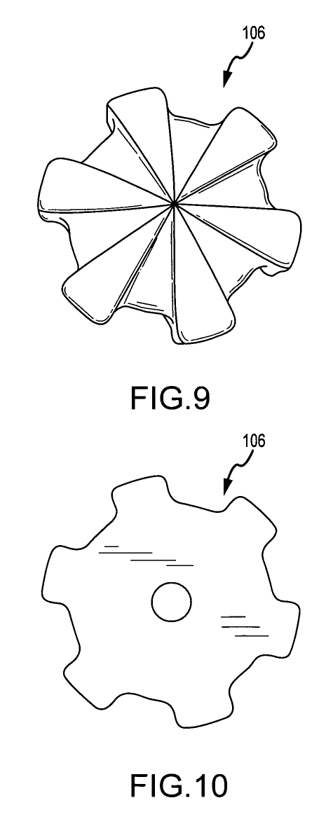

FIGS. 5-15 illustrate various components and exemplary stages in the application and/or installation of a window protection system, according to embodiments of the present invention. FIG. 5 illustrates a top view and FIG. 6 illustrates a bottom view of a retaining element 100 according to embodiments of the present invention. FIG. 7 illustrates a top view and FIG. 8 illustrates a side view of a suction element 101 according to embodiments of the present invention. FIG. 9 illustrates a top view and FIG. 10 illustrates a bottom view of a tensioning knob 106 according to embodiments of the present invention.

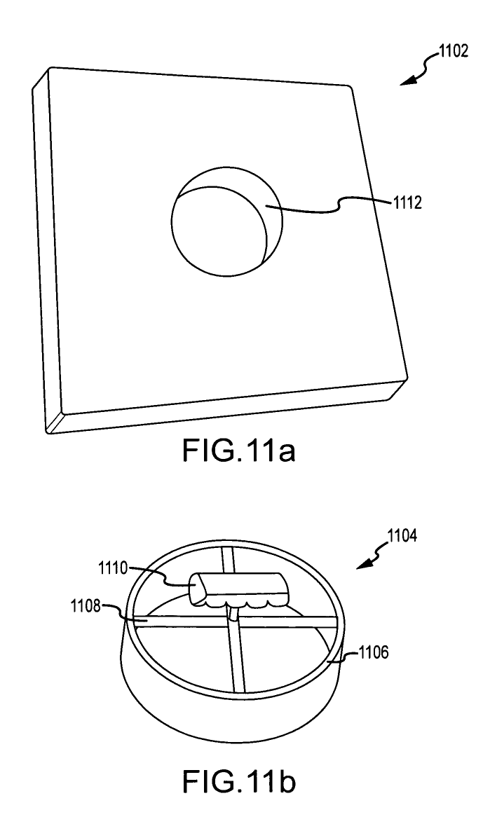

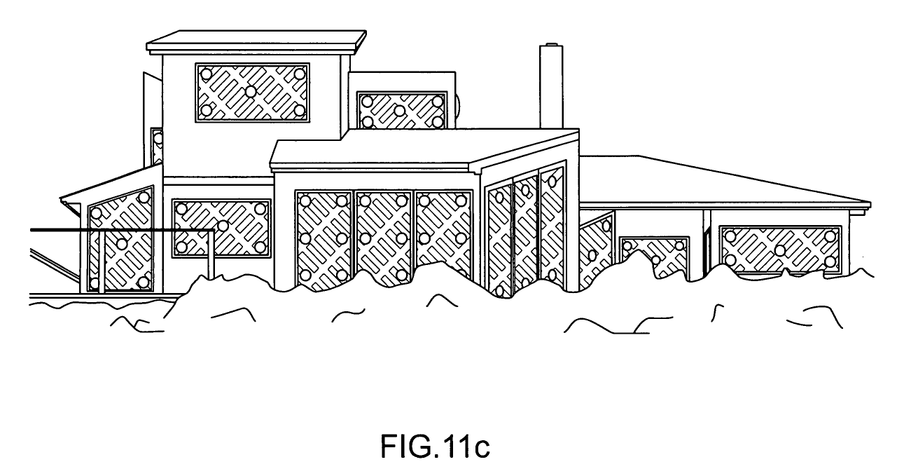

FIG. 11a illustrates a top perspective view of a protective sheet 1102 according to embodiments of the present invention. According to embodiments of the present invention, the protective sheet 1102 is constructed with a polypropylene foam. According to some embodiments, the protective sheet 1102 is constructed with a polypropylene foam having a density of 2.2 pounds per cubic foot; according to other embodiments, the protective sheet 1102 is constructed with a polypropylene foam having a density of about nine pounds per cubic foot; according to yet other embodiments, the protective sheet 1102 is constructed with one or more layers of foam having different densities and/or different protection characteristics either singly or in combination. The protective sheet may also include a Mylar laminated surface and/or one or more Mylar layers interspersed with foam layers, according to embodiments of the present invention. According to embodiments of the present invention, the protective sheet is buoyant in water.

FIG. 11a illustrates a protective sheet 1102 with a hole 1112 that has already been cut. According to embodiments of the present invention, hole 1112 may be cut using a cutting tool 1104. For example, a cutting tool 1104 as depicted in FIG. 11b may include a circular cutting surface 1106 (with saw teeth or a knife edge, for example) to which one or more crossbars 1108 and/or handles 1110 are attached in order to facilitate the pressing of the cutting tool 1104 against the protective sheet 1102 and/or the turning of the cutting tool 1104 to cut the hole 1112, according to embodiments of the present invention. According to other embodiments of the present invention, the hole 1112 may be cut through the protective sheet 1102 with a conventional tool such as, for example, a razor blade or utility knife. According to embodiments of the present invention, the cutting tool 1104 and the hole 1112 in the protective sheet 1102 roughly correspond in diameter to an outer diameter of neck 102. According to embodiments of the present invention the hole 1112 in the protective sheet 1102 may be precut. According to embodiments of the present invention, one or more holes 1112 may be cut in the protective sheet 1102.

According to embodiments of the present invention, the protective sheet 1102 may be precut for easy transportation. According to embodiments of the present invention, the protective sheet 1102 may be precut to fit various window sizes. The protective sheets 1102 may, for example be fit to window sizes on a house or building as is shown in FIG. 11c. According to embodiments of the present invention, the protective sheet 1102 may be cut and shaped with a conventional tool, such as, for example, a razor blade or utility knife, to fit to the size of any shaped windows.

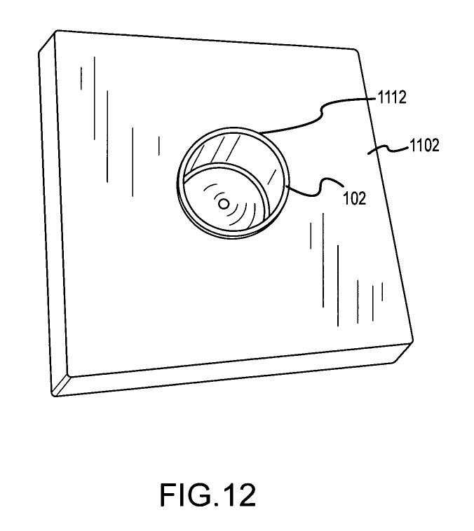

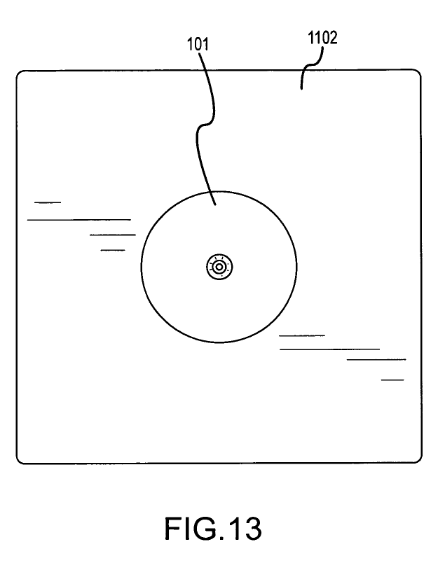

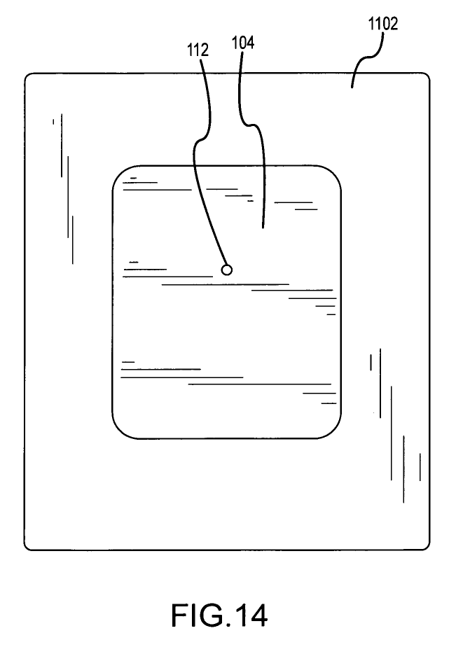

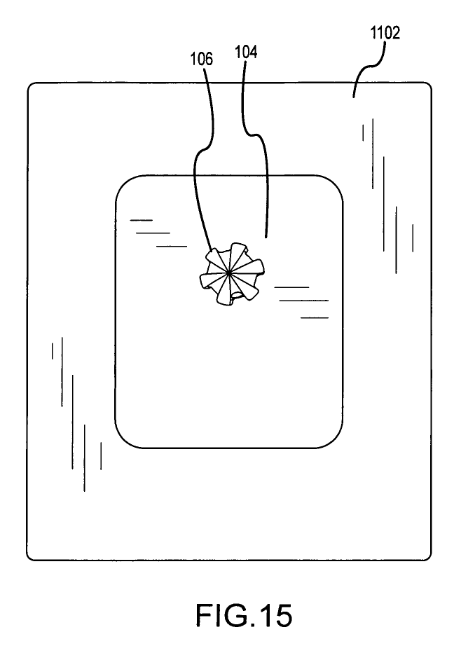

Once the neck 102 of the retaining element 100 has been placed through the hole 1112 on one side of the protective sheet 1102 (as illustrated in FIG. 12), the suction element 101 may be inserted on the hole 1112 on the other side of the protective sheet 1102, stem 112 first (as illustrated in FIG. 13). FIG. 13 illustrates a suction element 101 inserted on a protective sheet 1102 according to embodiments of the present invention. The stem 112 of the suction element 101 may be inserted through the hole 114 formed in the retention plate 104, as shown in FIG. 14, and the tensioning knob 106 may be threaded onto the tip of the stem 112, as shown in FIG. 15. The entire system may then be placed against a underlying surface 1602 with the suction cup 108 contacting the window pane (as illustrated in FIGS. 16 and 17), and the tensioning knob 106 may be tightened to raise the displacement disk 110 of the suction cup 108 and create a suction and/or vacuum between the suction cup 108 and the window pane. This suction holds the retaining element 100, tensioning knob 106, and protective sheet 1102 against the window pane, according to embodiments of the present invention. Based on the disclosure provided herein, one of ordinary skill in the art will appreciate that the above-described assembly and/or installation stages may be accomplished in a differing order, and that all or less than all of the steps may be included in each instance, according to some embodiments of the present invention.

FIG. 16 illustrates a side cross sectional view of a retention plate 100, suction cup 108, protective layer 1102, underlying surface 1602 and tensioning knob 106, according to embodiments of the present invention. FIG. 17 illustrates a transparent side cross sectional view of the retention plate 100, the suction cup 108, protective layer 1102, stem 112 and tensioning knob 106 of FIG. 16 in a suction configuration, according to embodiments of the present invention. One end 118 of neck 102 contacts the top of suction cup 108, and stem 112 has a length which permits it to protrude through hole 114 when neck 102 contacts suction cup 108, according to embodiments of the present invention. Stem 112 is connected to and/or protrudes from a displacement disk 110 within suction cup 108. Movement of stem 112 in a direction substantially in a direction away from underlying surface 1602 causes a corresponding movement of the center of suction cup 108 to be lifted away from the underlying surface 1602 while the outer portions of suction cup 108 remain between the bottom end 118 of neck 102 and the underlying surface, such as the underlying window pane. This causes a suction and/or vacuum to be created in the space between suction cup 108 and the window pane as depicted in FIG. 17, thereby securely holding the suction cup 108 to the window pane, according to embodiments of the present invention.

It is also contemplated that the components of the above-described system may be assembled and/or sold as a kit, according to embodiments of the present invention. For example, a kit may include one or more retaining elements 100, one or more suction elements 101, one or more tensioning knobs 106, and one or more protective sheets 1102, according to embodiments of the present invention. Such a kit may further include one or more cutting tools 1104, according to embodiments of the present invention.

According to some embodiments of the present invention, the use of white and/or clear foam to construct the protective sheet may permit ambient light, such as sunlight, to pass through the protective sheet, whereas plywood applied over a window tends to block all sunlight. According to yet other embodiments of the present invention, the attachment element may have a viewing port. The viewing port may be, for example, a lens or other similar device incorporated into retaining element 100 and/or suction element 101 to permit a person to see through the window protection device from the inside even when the device has been installed.

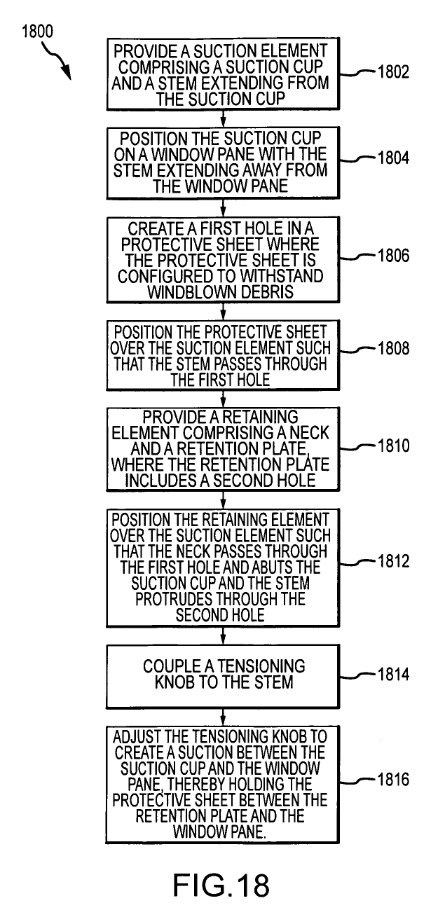

FIG. 18 depicts a flow diagram 1800 illustrating a method for protecting a window, according to embodiments of the present invention. According to embodiments of the present invention, a method for protecting a window includes providing a suction element 101 with a suction cup 108 and a stem 112 extending from the suction cup 108 (block 1802). The suction cup 108 may be positioned on a window pane with the stem 112 extending away from the window pane (block 1804). A first hole 1112 may be created in a protective sheet 1102 (block 1806), with the protective sheet 1102 configured to withstand windblown debris. The protective sheet may be positioned over the suction element 101 such that the stem 112 passes through the first hole 1112 (block 1808). A retaining element 100, which includes a neck 102 and a retention plate 104, may be provided, and the retention plate 104 may include a second hole 114 (block 1810). The retaining element 100 may be positioned over the suction element 101 such that the neck 102 passes through the first hole 1112 and abuts the suction cup 108 and the stem 112 protrudes through the second hole 114 (block 1812). A tensioning knob 106 may be coupled to the stem 112 (block 1814). The tensioning knob 106 may be adjusted to create a suction between the suction cup 108 and the window pane, thereby holding the protective sheet 1102 between the retention plate 104 and the window pane (block 1816). Based on the disclosure provided herein, one of ordinary skill in the art will recognize that various steps may be performed in different orders, and that less than or more than all of the described steps may be used in a particular method, according to embodiments of the present invention.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modification, and variations as fall within the scope of the claims, together with all equivalents thereof.

What is claimed is:

1. A system for protecting a window, the system comprising:
an attachment element comprising a retaining element and a suction element, the suction element configured to engage an underlying surface;
a protective sheet configured for placement between the retaining element and the underlying surface; and
a tensioning element configured to create suction between the suction element and the underlying surface.

2. The system of claim 1, wherein the retaining element comprises a neck and a retention plate, wherein the retention plate includes a hole, wherein the suction element comprises a suction cup and a stem extending from the suction cup, and wherein the stem passes through the hole when the neck contacts the suction cup.

3. The system of claim 2, wherein the suction element further comprises a displacement disk inside the suction cup, the displacement disk coupled with the stem.

4. The system of claim 2, wherein the neck has an outer diameter, and wherein the protective sheet includes a aperture with a diameter greater than or equal to the outer diameter of the neck.

5. The system of claim 2, wherein the tensioning element comprises a tensioning knob, and wherein an adjustment of the tensioning knob axially displaces the stem to create suction between the suction cup and the underlying surface.

6. The system of claim 5, wherein the tensioning knob is coupled with the stem via a threadable connection.

7. The system of claim 5, wherein the tensioning knob is coupled with a portion of the stem passing through the hole.

8. The system of claim 1, wherein the underlying surface is a window pane.

9. The system of claim 8, wherein the window pane is glass.

10. The system of claim 1, wherein the protective sheet comprises a foam layer.

11. The system of claim 10, wherein the foam layer comprises a polypropylene foam.

12. The system of claim 10, wherein the protective sheet further comprises a Mylar layer.

13. The system of claim 1, wherein the protective sheet comprises a Mylar layer.

14. The system of claim 1, wherein the protective sheet permits the passage of ambient light.

15. The system of claim 1, wherein the protective sheet is buoyant in water.

16. The system of claim 1, wherein the attachment element includes a viewing port.

17. A method for protecting windows, the method comprising:
providing a suction element comprising a suction cup and a stem extending from the suction cup;
positioning the suction cup on a window pane with the stem extending away from the window pane;
creating a first hole in a protective sheet, the protective sheet configured to withstand windblown debris;
positioning the protective sheet over the suction element such that the stem passes through the first hole;
providing a retaining element comprising a neck and a retention plate, wherein the retention plate includes a second hole;
positioning the retaining element over the suction element, such that the neck passes through the first hole and abuts the suction cup and the stem protrudes through the second hole;
coupling a tensioning knob to the stem; and
adjusting the tensioning knob to create a suction between the suction cup and the window pane, thereby holding the protective sheet between the retention plate and the window pane.

18. A kit for protecting windows, the kit comprising:
one or more retaining elements comprising a neck and a retention plate;
one or more suction elements comprising a suction cup and a stem extending from the suction cup; and
one or more tensioning knobs configured to interface with the stem, wherein an adjustment of the tensioning knob axially displaces the stem to create suction between the suction cup and an underlying surface while holding the retaining element to the underlying surface.

19. the kit of claim 18, further comprising:
a protective sheet configured to be held between the retention plate and the underlying surface.
